(19) United States
(12) Patent Application Publication
(10) Pub. No.: US 2008/0309586 A1
(43) Pub. Date: Dec. 18, 2008

(54) Viewing System for Augmented Reality Head Mounted Display

(76) Inventor: Anthony Vitale, Bay Harbor Island, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/762,171

(22) Filed: Jun. 13, 2007

(51) Int. Cl. G09G 5/00

(52) U.S. Cl. 345/8

(57) ABSTRACT

The viewing system is a head mount display (eye glasses, goggles, head piece or helmet) with emitters on the user's nose bridge emitting an optical image towards reflector screens a predetermined distance from the user's cornea or eye. Each emitter unit is fed with a signal forming the optical image and, in one embodiment, the emitter unit has a plurality of emitters semi-hemispherically mounted to direct light towards the reflector screen. In one embodiment, each reflector screen is a semi-hemispherical reflector with a plurality of discrete reflection surfaces, each at a discrete angle for directing light into the user's eye. In another, the reflector screen is an ellipse and the reflection surface does not have discrete reflection surfaces or facets. Contacts may magnify the optical image.

The present invention relates to a viewing system, configured as glasses, goggles, head piece or a helmet, wherein optical images are projected from nose bridge emitter units towards reflective screens (on the inboard surfaces of the glasses, goggles or helmet eye shield) which direct the optical image into respective eyes of the user.

### BACKGROUND OF THE INVENTION

Development of virtual retina display technology or VRI) has been investigated by the Navy and at the Human Interface Technology Lab of Washington University. Microvision, of Redmond Wash., manufactures a see through heads up display that overlays computer based information over real world images permitting the operator hands free, head up access to digital information at any time and anywhere.

### OBJECTS OF THE INVENTION

It is an object of the present invention to provide a viewing system for an augmented reality head mounted display.

It is a further object of the present invention to provide a pair of emitter units removably mounted effectively on the bridge of a user's nose, which emitters point to reflector screens configured as goggles, eye glasses or screens depending from a head piece or helmet, which reflector screens reflect the optical image transmitted by the emitter unit onto the eye of the user.

It is a further object of the present invention to provide the user with magnifying contact lenses to improve the optical image size.

It is another object of the present invention to provide reflective surfaces with either a flat surface, concave surface or a diffraction grating surface and wherein, in certain embodiments, these reflective surfaces are a plurality of surfaces, each surface having a discrete reflection angle.

It is a further object of the present invention to provide reflective screens which are semi-spherical ellipsoid reflectors which eliminate the plurality of discrete reflection surfaces.

### SUMMARY OF THE INVENTION

The viewing system for a head mount display is worn by a user and is mounted on or about the bridge of a user's nose such that emitters are a predetermined distance away from reflector screens which direct optical images into respective ones of the user's eyes. The head mount (eye glasses, goggles, head piece or helmet) specially mounts each emitter unit, left and right for the left and right eyes respectively, a predetermined distance away from a corresponding reflector screen. Each emitter unit is coupled to an image generator via a signal line. An optical image is emitted from the emitter unit. In one embodiment, the emitter unit has a plurality of emitters configured in a semi-hemispherical manner to emit an optical image substantially radially towards the corresponding reflector screen. In one embodiment, each reflector screen is a semi-hemispherical reflector with a plurality of discrete reflection surfaces. Each discrete reflection surface reflects a portion of the optical image at a discrete angle such that the optical image from the emitter unit is directed into the user's eye. In another embodiment, the reflector screen is an ellipse and the reflection surface need not have discrete reflection surfaces or facets since the ellipsoid reflector is positioned such that one focii of the ellipse is at the radial center point of the emitters and the other focii of the ellipse is at either the cornea of the eye or at the optical center of the eye.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates the user's eyes, the emitters and the reflector screens;

FIGS. 2A and 2B diagrammatically illustrate the reflector screens and emitter units mounted on glasses or goggles and diagrammatically illustrate a helmet or head piece with depending reflector screens (eye shields);

FIG. 3 diagrammatically illustrates the optical operation of the system;

FIG. 4 diagrammatically illustrates the technique for focusing collimated light;

FIG. 5 diagrammatically illustrates the plurality of emitter units on the semi-hemispherical emitter unit;

FIGS. 6A and 6B diagrammatically illustrate emitter unit and discrete reflection surfaces from the reflector;

FIG. 7 diagrammatically illustrates one configuration for the discrete reflector surfaces on the reflector screen;

FIGS. 8A, 8B and 8C diagrammatically illustrate shallow concave reflection surfaces for the plurality of discrete reflection surfaces in the reflector, a different shape for those discrete reflection surfaces (tear drop shape) and a diffraction grating used for the reflection surfaces;

FIGS. 9A, 9B and 9C diagrammatically illustrate contacts worn by the user to magnify the image projected by emitters and reflected from the reflector screens;

FIGS. 10, 11 and 12 diagrammatically illustrate the light reflection principles of an ellipsoid, one reflective surface configured as a semi-spherical ellipsoid, and a second reflective surface configured as ellipsoid.

### DETAILED DESCRIPTION OF THE PREFERRED EMBODIMENTS

The present invention relates to a viewing system for head mounted display worn by a user and mounted on and about the bridge of a user's nose with reflector screens mounted on the user's head via glasses or head mount helmet or cap.

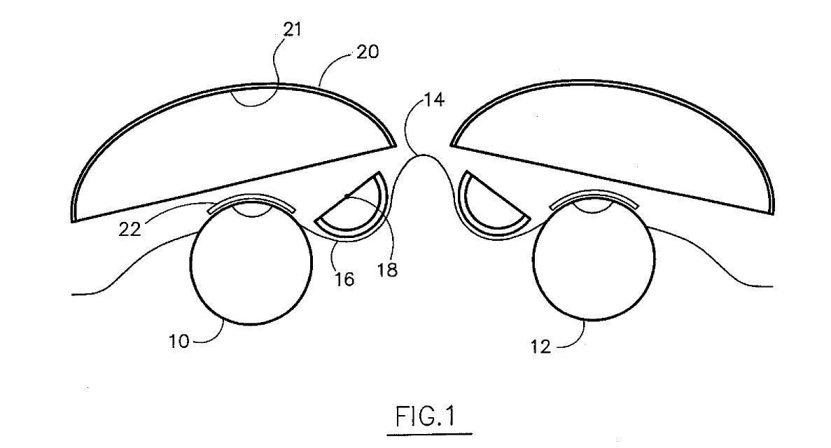

FIG. 1 diagrammatically illustrates a user's left eye 10 and right eye 12 as well as the nose bridge 14 of the user. FIG. 1 diagrammatically illustrates the viewing system which includes a pair of emitter units which are mounted on or about the bridge of nose 14 and a pair of reflector screens, each screen corresponding to a certain emitter unit. Similar numerals designate similar items throughout the drawings. Only one emitter-reflector screen system is described in detail. Persons of ordinary skills in the art recognize that the opposite side emitter-reflector system is substantially similar.

In FIG. 1, a semi-hemispherical emitter unit 16 is mounted on or near the bridge of nose 14. Emitter unit 16 has a plurality of emitters therein which effectively generate an optical image through center point 18. This optical image is projected radially onto a specially configured reflector screen 20. Due to the reflection of the inboard side 21 of reflector screen 20, the optical image is then directed or reflected into user eye 10. In order to magnify the image, the user may employ magnifying contacts 22.

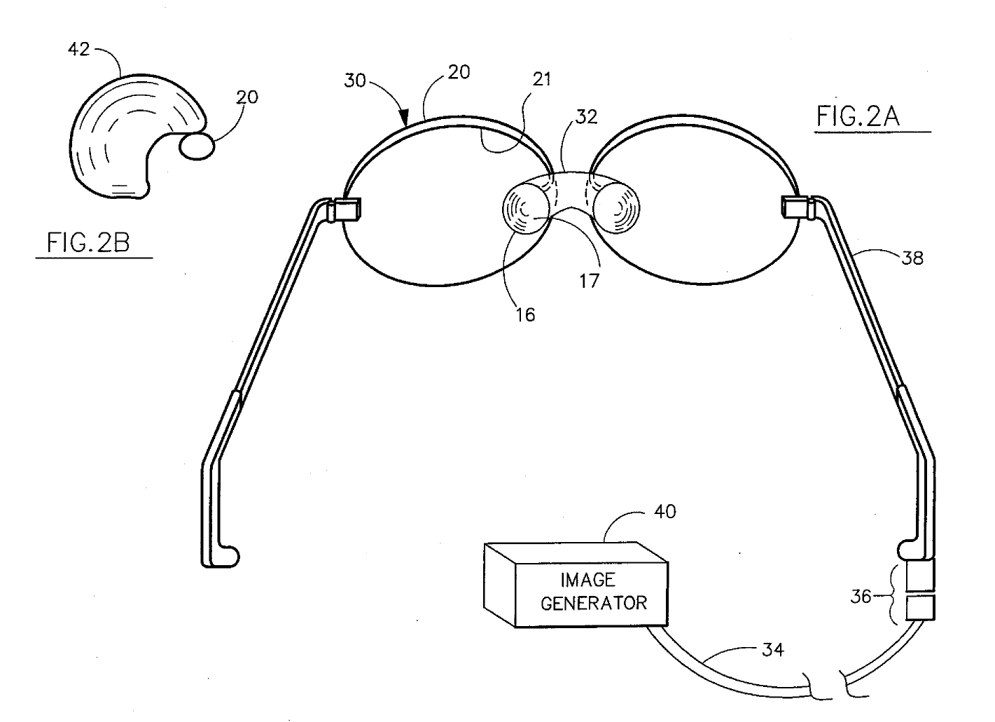

FIG. 2A shows spectacles (eye glasses) or goggles 30 and the back side 17 of emitter unit 16. A goggle nose bridge 32 is adopted to rest on nose bridge 14 of the user. Emitter backside 17 may also rest on the user's nose. The inboard reflective surface 21 of reflector screen 20 is shown. In order to transfer signals representing the optical image to the pair of emitter units 16, goggle or spectacle 30 includes, in the illustrated embodiment, signal line 34. A removable coupling 36 permits the user to attach and detach signal line 34 to the glasses or helmet. Of course, further portions of signal line 34 extend through arm 38 (or the helmet) to both emitter units 16. An image generator 40 generates an image which is applied to signal line 34. In one embodiment, an optical image is generated by image generator 40 and this optical image is carried by fiber optics in signal line 34. Alternatively, the emitter units 16 may be electronic light generators such as LEDs or other light emitting elements and electronic signals could be carried by signal line 34. In this situation, image generator 40 generates electronic signals which correspond to the image.

FIG. 2B shows a head piece or helmet 42 which is mounted on the head of the user such that the optical image from emitter units 16 is projected to a depending reflector screen 20 and then redirected to the eye of the user. The left and right screens drop below the front edge of the helmet and may act as eye shields. The emitters also depend from the helmet and rest on or near the user's nose bridge. Optical fibers in signal line 34 may reduce electrical noise and unwanted radiation which maybe generated by electrical light emitters 16.

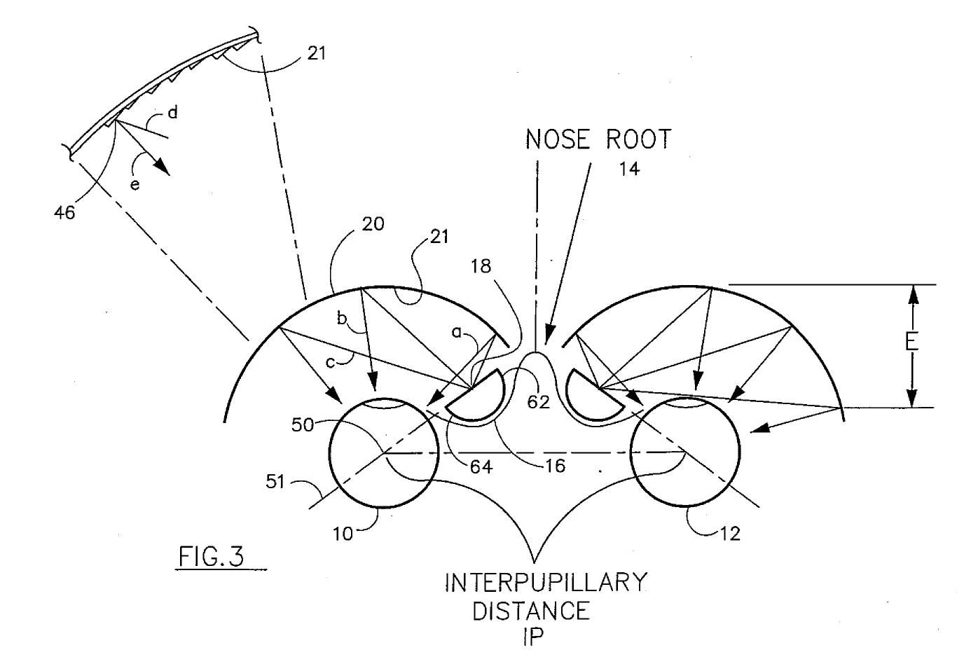

FIG. 3 shows that radial light rays leave light emitter unit 16 and are reflected back to the eye by the reflector screen, that is, rays a, b, and c are optically processed at the end of the emitters and are reflected back into eye 10. The inboard surface 21 of reflector screen 20 includes a plurality of discrete reflection surfaces each having a discrete angle to direct the optical image from the emitter unit into the user's eye. Therefore, in the expanded view in the upper left of FIG. 3, inboard surface 21 has a plurality of discrete reflection surfaces, one of which is surface 46, wherein optical image ray d strikes discrete reflective surface 46 and the angle of incidence and the angle of reflectance results in ray C being directed into the eye 10 of the user. FIG. 3 shows that the pair of emitter units 16 are placed a predetermined distance from the user's eye (distance from the centerline of the nose) when taking into account the distance between radial centerpoint 18 of emitter 16 and the reflection of the light towards eye 10. In this embodiment, eye 10 has an optical centerpoint 50 that falls on line 51 defined by the forward edge of semi-hemispherical emitter unit 16. Calculations indicate that there is a reasonable common interpupillary distance or IP for most users. Further, the distance from the user's cornea or the contact lens on the cornea to the hemispheric reflective surface, that is, along the optical centerline of the eye—reflective surface combination, is approximately 25.4 mm (essentially, the distance from the bifocal magnifying lens 22 to the reflective surface). It has been observed that line 51 identifies the typical maximum angle of rotative movement of eye 10. Therefore, the user either would not see emitter unit 16 on his or her nose bridge or would only see a very small portion thereof. In one embodiment, emitter 16 has light transmitters of the same size. In another embodiment, the size of the emitter surfaces varies.

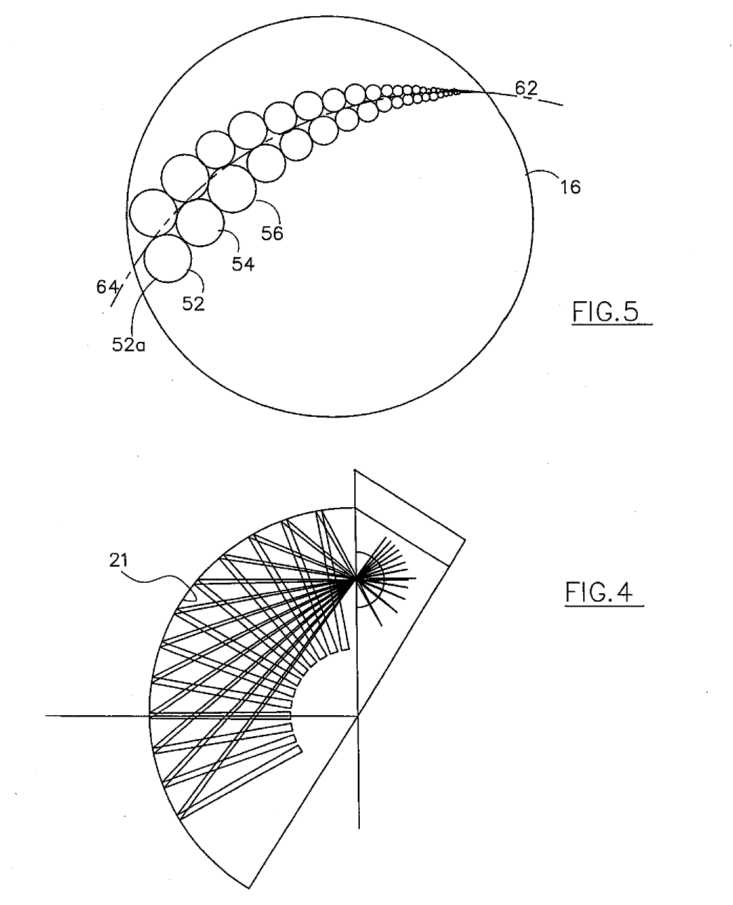

FIG. 4 diagrammatically shows that collimated light, when reflected from reflective surface 21, can be directed to a singular point. That singular point is preferably at or immediately below the cornea of the user's eye. In one embodiment, it is believed that the semi-hemispherical emitter 16 must have a plurality of emitter units having different sizes. In another embodiment, the emitters have the same size or radii generating the optical image.

FIG. 5 shows emitter 16 having a plurality of discrete emitters 52, 54, 56 that have a progressively smaller size along an arc from the inboard edge of the semi-hemispherical emitter body near the eyeball to the outer hemispherical edge distal from the eye. The size change of the emitter surfaces, from proximal to distal positions, is shown in FIG. 5. One emitter surface is emitter surface 52a. The change in emitter radii is not a constant change in radius. Further, the semi-hemispherical emitter unit 16 itself forms a concave projector wherein the emitter surface or light projection emitting pixels (surface 52a) are smaller on outboard side 62 as compared with inboard side 64. Inboard or proximal side 64 is nearer to the eye as shown by side 64 in FIG. 3. Side 62 is outboard or distal with respect to eye 10. The different sizes of the emitters compensate for the longer distances traveled by rays c (FIG. 3) as compared to short distance rays a.

The distance from the cornea of eye 10 to the outboard edge of reflective surface 20 is approximately 25.4 mm. This is distance e in FIG. 3.

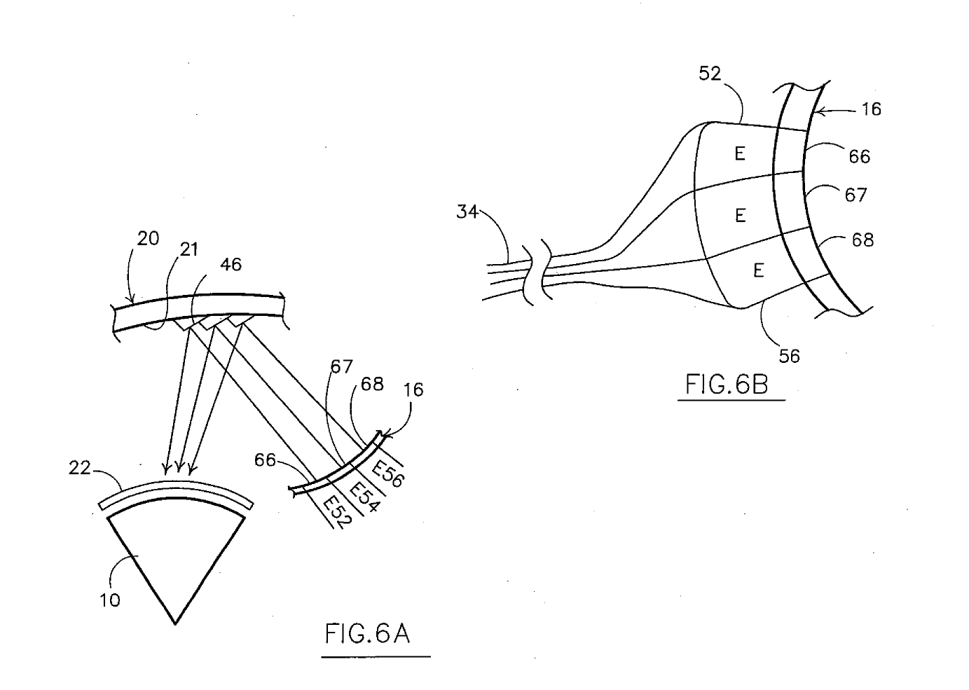

FIG. 6A shows a portion of emitter unit 16 and particularly emitters 52, 54 and 56. These emitters may have emitting surfaces tightly packed on the concave unit 16. Each emitter may have, mounted thereon, an optical lens, one of which is lens 66 on emitter 52. Faceplates may be used also (see faceplates manufactured by Schott of Germany). By having different faceplates or lenses 66, 67, 68, it may be possible to have a uniform set of emitters (same radii) on emitter unit 16 and vary the type or degree of image magnification or diffusion via lenses 66, 67, 68. Alternatively, or in addition to, lenses 66, 67, 68 may be cylinders which further collimate the light directed to reflector screen 21. It's beneficial that the light be collimated as much as possible in order to correctly optically transmit the image into eye 10.

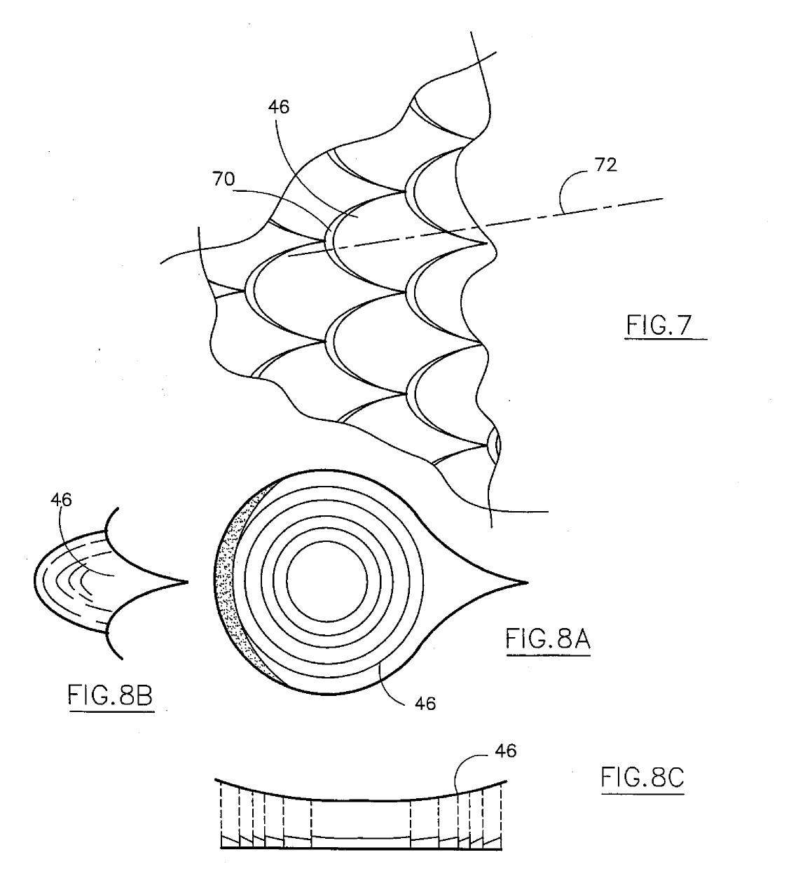

FIGS. 7 and 8A-8C diagrammatically show different shapes of the reflective surfaces 46 on the reflector screen. Reflective surface or facet 46 is at an appropriate or predetermined angle such that reflective surface edge face 70 is aligned or in line with imaginary line 72 which is parallel to incoming optical rays b (FIG. 3) from emitter 16 and the reflective surface transmits the light into the eye. In this manner, most of the optical image ray b is reflected from reflection surface 46 and only a small amount is reflected or deflected due to the edge face 70.

FIG. 8A shows that reflection surface 46 maybe generally circular (the overall shape in the reflector plate). Optionally, the reflective surface may be planar or may have a slightly concave shape which shape redirects and focuses light back into eye 10. FIG. 8B shows that reflective surface 46 in the reflector plate plane may be tear drop shaped. The packing ratio of the reflective surfaces can be designed by a computer. FIG. 8C shows that reflective surface 46 may include a diffraction grating.

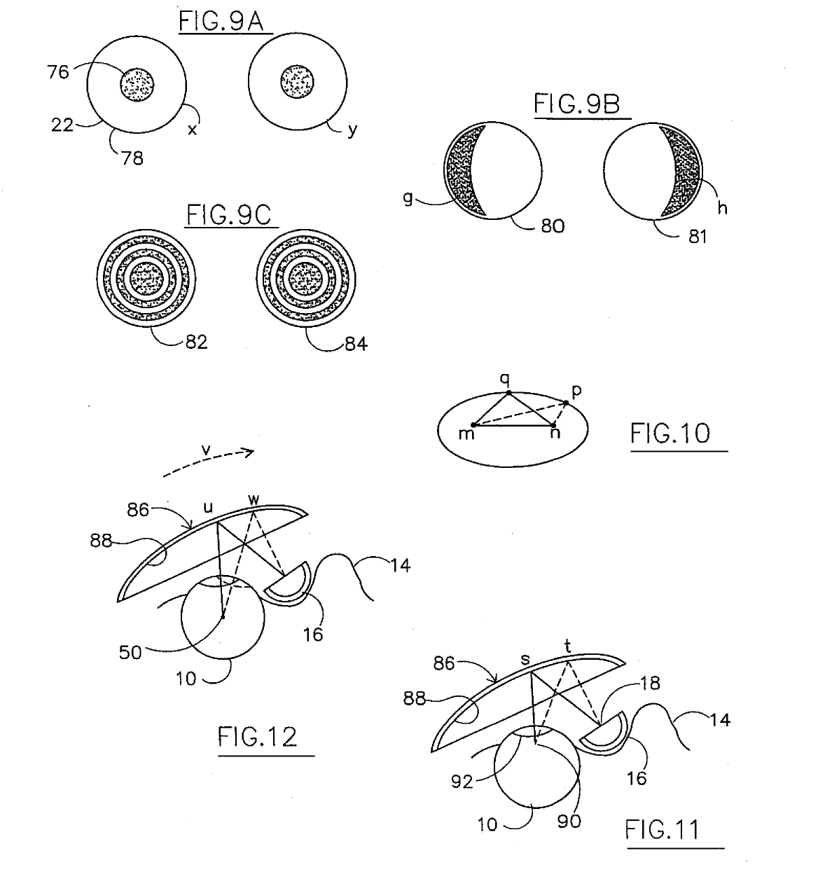

In order to magnify the optical image, each of the user's eyes may wear a contact 22. Dependent upon the optical processing of the optical image by the system as a whole, the user may or may not wear contact lenses to magnify the optical image. The contacts may be full field of view magnifiers or partial view magnification. One partial view contact with a central region 76 magnification (about plus 15.5 diopter) and a clear or zero magnification in peripheral region 78 (see FIG. 9A). Another partial view magnification is lenses 80, 81 have outboard peripheral regions g, h in FIG. 9B which have a magnification plus 15.5 diopters. The inboard regions are zero diopters. Contact lenses 82, 84 in FIG. 9C have a plurality of annular rings wherein each annular ring has the same magnification power. The preferred embodiment of an ellipsoid (FIG. 12) may use a contact with magnification in central region 76 (about +22 diopter).

FIGS. 10, 11 and 12 diagrammatically show the optical performance of a semi-spherical ellipsoid as a reflective screen. FIG. 10 diagrammatically shows an ellipsoid with focii at points m and n. The distance of line nq plus qm is the same as the distance of combined line np plus pm. Therefore, in FIG. 11, light emitted from emitter unit 16 and effectively from center point 18 of emitter unit 16 follows path t or path s which paths both traverse the same distance into eye 10. In this embodiment, the focal point of the rays from reflection points t or s are directed at focal point 90. Focal point 90 is at or very close to the cornea 92 of eye 10. The focii of reflector screen is 18 and 90. This semi-spherical ellipsoid position (FIG. 11) generally permits only straight on vision. In other words, to achieve the augmented visual experience, the user must look straight forward and not side to side. Reflective screen 86 has an ellipsoid surface which is semi-spherical 88.

FIG. 12 shows the semi-spherical ellipsoid surface 88 where the distance traveled by w optic ray or u optic ray is focused to eye center point 50. Eye centerpoint 50 is one of the focii of the ellipsoid. In this manner, when eye 10 rotates as shown by the dashed line v, the optical image is directed into the interior of the eye.

The reflective screens do not block inboard directed or ambient light. Therefore, this inboard directed ambient light mixes optically with the emitted-reflected light and the combination forms an augmented reality for the user. The reflector may be characterized as a thin screen such that non-reflected emitter rays traversing the reflector plate are minimal.

The claims appended hereto are meant to cover modifications and changes within the scope and spirit of the present invention.

What is claimed is:

1. A viewing system for a head mounted display worn by a user and mounted on or about the bridge of the user's nose a predetermined distance beyond the user's eyes, said viewing system supplied with image signals from an image generator comprising:
a pair of emitter units pointed at a corresponding pair of reflector screens which direct optical images into respective opposite ones of said user's eyes;
a head mount worn by said user which spatially mounts each emitter unit a predetermined distance away from the corresponding reflector screen and spatially mounts each reflector screen a further predetermined distance away from the corresponding user eye;
each emitter unit coupled to said image generator via a signal line, each emitter having a plurality of emitters configured semi-hemispherically to emit said optical image substantially radially towards said corresponding reflector screen; and
each reflector screen being a semi-hemispherical reflector with a plurality of discrete reflection surfaces, each discrete reflection surface reflecting said optical image at a discrete angle to direct said optical image from said emitter unit into said user's eye.

2. A viewing system as claimed in claim 1 including a pair of eye contacts worn on said user's eyes which eye contact magnify said optical image directed thereon by said pair of emitters and said pair of reflecting screens.

3. A viewing system as claimed in claim 1 wherein each said semi-hemispherical emitter unit has a proximal region near the corresponding user eye and a distal region away from said corresponding user eye, said plurality of emitters in each emitter unit have a respective plurality of emission surfaces which vary in size and wherein larger emission surfaces are disposed on said proximal region nearer said corresponding user eye and smaller emission surfaces are disposed on said distal region.

4. A viewing system as claimed in claim 1 wherein each said discrete reflection surface is a reflective surface from the group of reflective surfaces including a flat surface, concave surface and a reflective grating surface.

5. A viewing system as claimed in claim 1 wherein each said discrete reflection surface has a shape from the group of shapes including a circular shape, a truncated circular shape, a tear drop shape, an ellipsoidal shape, and a truncated ellipsoidal shape.

6. A viewing system as claimed in claim 1 wherein said pair of reflector screens permit ambient light and images to pass therethrough into said user's eyes.

7. A viewing system as claimed in claim 1 wherein said head mount is a pair of spectacles worn by said user.

8. A viewing system as claimed in claim 1 wherein said head mount is one of a helmet, hat or head piece worn by said user.

9. A viewing system as claimed in claim 2 wherein said each contact of said pair of eye contacts has a central region which magnifies said optical image.

10. A viewing system as claimed in claim 2 wherein said each contact of said pair of eye contacts has a successively larger annular regions wherein each annular region uses the same magnification for said optical image.

11. A viewing system as claimed in claim 2 wherein said each contact of said pair of eye contacts has an outboard region away from the user's nose wherein said outboard region of each contact magnifies said optical image.

12. A viewing system for a head mounted display worn by a user and mounted on or about the bridge of the user's nose a predetermined distance beyond the user's eyes, said viewing system supplied with image signals from an image generator comprising:
a pair of emitter units pointed at a corresponding pair of reflector screens which direct optical images into respective opposite ones of said user's eyes;
a head mount worn by said user which spatially mounts each emitter unit a predetermined distance away from the corresponding reflector screen and spatially mounts each reflector screen a further predetermined distance away from the corresponding user eye;
each emitter unit coupled to said image generator via a signal line, each emitter having a plurality of emitters configured semi-hemispherically to emit said optical image substantially radially towards said corresponding reflector screen; and
each reflector screen being a semi-spherical ellipsoid reflector with a reflection surface which angularly reflects said optical image from said emitter unit towards and into said user's eye.

13. A viewing system as claimed in claim 12 including a pair of eye contacts worn on said user's eyes which eye contact magnify said optical image directed thereon by said pair of emitters and said pair of reflecting screens.

14. A viewing system as claimed in claim 1 wherein each said semi-hemispherical emitter unit has a proximal region near the corresponding user eye and a distal region away from said corresponding user eye, said plurality of emitters in each emitter unit have a respective plurality of emission surfaces which vary in size and wherein larger emission surfaces are disposed on said proximal region nearer said corresponding user eye and smaller emission surfaces are disposed on said distal region.

15. A viewing system as claimed in claim 12 wherein said pair of reflector screens permit ambient light and images to pass therethrough into said user's eyes.

16. A viewing system as claimed in claim 12 wherein said head mount is a pair of spectacles worn by said user.

17. A viewing system as claimed in claim 12 wherein said head mount is one of a helmet, hat or head piece worn by said user.

18. A viewing system as claimed in claim 13 wherein said each contact of said pair of eye contacts has a central region which magnifies said optical image.

19. A viewing system as claimed in claim 13 wherein said each contact of said pair of eye contacts has a successively larger annular regions wherein each successive annular region has the same magnification for said optical image.

20. A viewing system as claimed in claim 13 wherein said each contact of said pair of eye contacts has an outboard region away from the user's nose wherein said outboard region of each contact magnifies said optical image.
